(19) United States
(12) Patent Application Publication
(10) Pub. No.: US 2012/0078535 A1
(43) Pub. Date: Mar. 29, 2012

(54) ABNORMALITY DETERMINATION APPARATUS

(75) Inventors: Takashi Nakamura, Toyota-shi (JP); Takeho Aisaka, Toyota-shi (JP)

(73) Assignee: TOYOTA JIDOSHA KABUSHIKI KAISHA, Toyota-shi (JP)

(21) Appl. No.: 13/242,108

(22) Filed: Sep. 23, 2011

(30) Foreign Application Priority Data
Sep. 27, 2010 (JP) 2010-215177

(51) Int. Cl. G06F 19/00

(52) U.S. Cl. 702/35

(57) ABSTRACT

An abnormality determination apparatus includes: a detecting unit repeatedly detecting a state quantity, which correlates with an operating state of an evaluation target device, at time intervals; and a determining unit determining whether there is an abnormality on the basis of multiple pieces of data about the state quantity, detected by the detecting unit and stored. The apparatus counts the number of the stored data as a total storage number after there occurs a situation that no data are stored, permits the determining unit to execute abnormality determination on the condition that the total storage number has reached a first threshold in a first trip after the situation occurs, and permits the determining unit to execute abnormality determination on the condition that the total storage number has reached a second threshold that is smaller than the first threshold in a second trip or later after the situation occurs.

### INCORPORATION BY REFERENCE

The disclosure of Japanese Patent Application No. 2010-215177 filed on Sep. 27, 2010 including the specification, drawings and abstract is incorporated herein by reference in its entirety.

### BACKGROUND OF THE INVENTION

1. Field of the Invention

The invention relates to an abnormality determination apparatus that detects a state quantity that correlates with the operating state of a device to be subjected to abnormality determination and that determines whether there is an abnormality in the device on the basis of the detected data.

2. Description of Related Art

Japanese Patent Application Publication No. 7-36727 (JP-A-7-36727) describes an abnormality determination apparatus. The abnormality determination apparatus detects a state quantity that correlates with the operating state of a device to be subjected to abnormality determination (hereinafter, evaluation target device) and that determines whether there is an abnormality in the evaluation target device on the basis of a comparison between the detected data and a determination value.

In the above abnormality determination apparatus, when the detected data is merely compared with the determination value, adverse influence of disturbance, such as superimposition of noise on a detected signal and variations in detected data due to difference in the operating state of the evaluation target device, on determination accuracy may increase.

In order to suppress such adverse influence, it is conceivable to execute abnormality determination on the basis of multiple pieces of data detected and stored in a predetermined period in such a manner that not detected data at that moment is merely compared with the determination value but, for example, the state quantity is repeatedly detected at time intervals and then the average value or weighted average value of those pieces of detected data is calculated and compared with the determination value. With the thus configured apparatus, it is possible to execute abnormality determination on the basis of the detected tendency of the operating state of the evaluation target device in a predetermined period, so influence due to disturbance is suppressed to a lesser degree.

In the apparatus that executes abnormality determination on the basis of multiple pieces of data detected and stored in a predetermined period, pieces of data used in abnormality determination are consistent with an actual situation on the condition that a certain number of stored data are ensured, so high determination accuracy may be obtained in abnormality determination.

Therefore, when pieces of data for determination are unnecessarily lost because of, for example, temporary interruption of electric power supplied to the abnormality determination apparatus due to battery replacement and become initial values, this may lead to deterioration in the accuracy of abnormality determination until the state quantity has been repeatedly detected and then a predetermined number of stored data have been ensured thereafter.

Such deterioration in determination accuracy may be avoided by prohibiting abnormality determination over a period after pieces of data for determination are lost until the number of stored data for the state quantity reaches a predetermined value. However, in this case, abnormality determination may not be executed over a certain period, so the timing at which it is determined whether there is an abnormality delays accordingly. This is not desirable in terms of quickly determining whether there is an abnormality.

### SUMMARY OF THE INVENTION

The invention provides an abnormality determination apparatus that is able to execute abnormality determination with high accuracy and that is also able to quickly execute abnormality determination.

A first aspect of the invention relates to an abnormality determination apparatus. The abnormality determination apparatus includes: a detecting unit that repeatedly detects a state quantity, which correlates with an operating state of an evaluation target device, at time intervals; and a determining unit that determines whether there is an abnormality on the basis of multiple pieces of data about the state quantity, detected by the detecting unit and stored. The abnormality determination apparatus counts the number of the stored data as a total storage number after there occurs a situation that no data are stored, permits the determining unit to execute abnormality determination on the condition that the total storage number has reached a first threshold in a first trip after the situation occurs, and permits the determining unit to execute abnormality determination on the condition that the total storage number has reached a second threshold that is smaller than the first threshold in a second trip or later after the situation occurs.

With the above configuration, during the first trip immediately after there occurs a situation that no data are stored, abnormality determination is executed on the condition that a relatively large number (number corresponding to the first threshold) of new data are detected and stored. Although multiple pieces of data used for determination at this time may include data having low reliability, abnormality determination may be, executed after a sufficient number of new data for obtaining high determination accuracy are detected and stored, so it is possible to execute the determination with high accuracy. Moreover, in the second trip or later after there occurs a situation that no data are stored, abnormality determination is executed on the condition that a relatively small number (number corresponding to the second threshold) of new data are detected and stored after the situation occurs. Therefore, abnormality determination may be executed on the condition that a number of new data that are minimally required to maintain determination accuracy are detected and stored, so it is possible to avoid an unnecessary delay of the timing at which determination result is obtained while suppressing deterioration in determination accuracy.

In this way, with the above configuration, during the first trip immediately after there occurs a situation that no data are stored, abnormality determination may be executed initially on the condition that the number of stored data is sufficiently ensured, that is, importance is placed on high determination accuracy. Moreover, when proceeding to the second trip before the number of stored data reaches a sufficient number, abnormality determination may be executed on the condition that the number of stored data reaches a relatively small storage number, that is, importance is placed on early completion of abnormality determination. Thus, it is possible to execute abnormality determination with high accuracy and quickly execute abnormality determination.

A second aspect of the invention relates to an abnormality determination method. The abnormality determination method includes: detecting repeatedly a state quantity, which correlates with an operating state of an evaluation target device, at time intervals; determining whether there is an abnormality on the basis of multiple pieces of data about the state quantity that have been detected and stored in the detecting; counting the number of the stored data as a total storage number after there occurs a situation that no data are stored; permitting the determining to execute abnormality determination on the condition that the total storage number has reached a first threshold in a first trip after the situation occurs; and permitting the determining to execute abnormality determination on the condition that the total storage number has reached a second threshold that is smaller than the first threshold in a second trip or later after the situation occurs.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that shows the schematic configuration of an engine system to which an abnormality determination apparatus according to a specific embodiment of the invention is applied;

FIG. 2 is a flowchart that shows the specific procedure executed in active control;

FIG. 3 is a timing chart that shows an example of a mode in which active control is executed; and

FIG. 4 is a flowchart that shows the procedure executed in determination permitting process.

### DETAILED DESCRIPTION OF EMBODIMENTS

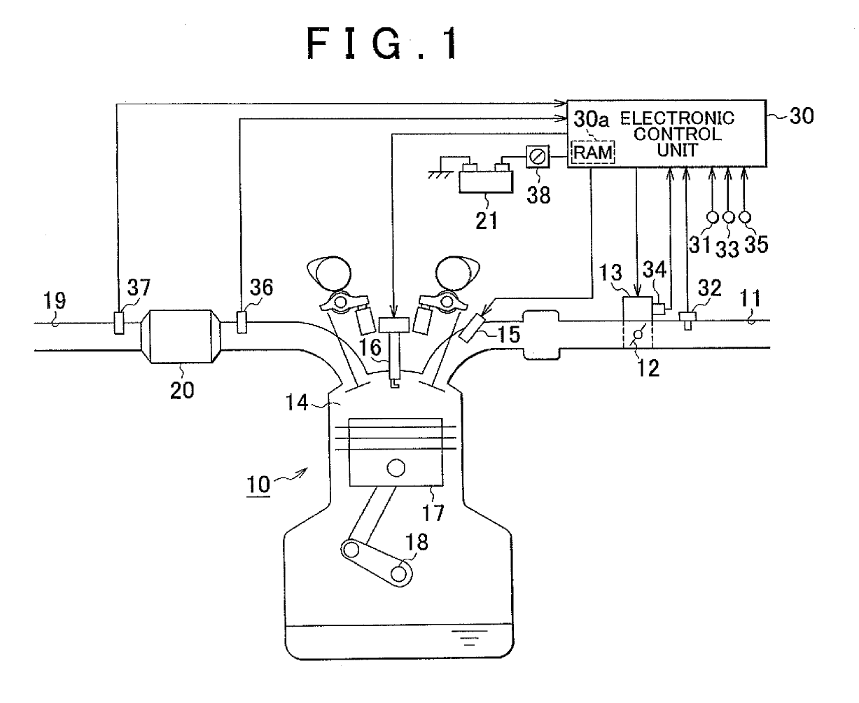

Hereinafter, an abnormality determination apparatus according to a specific embodiment of the invention will be described. FIG. 1 shows the schematic configuration of an engine system to which the abnormality determination apparatus according to the present embodiment is applied.

As shown in FIG. 1, a throttle valve 12 is provided in an intake passage 11 of an internal combustion engine 10. A throttle motor 13 is coupled to the throttle valve 12. Then, the opening degree of the throttle valve 12 (throttle opening degree TA) is adjusted through drive control over the throttle motor 13 (throttle control). By so doing, the amount of air taken into a combustion chamber 14 through the intake passage 11 is adjusted. A fuel injection valve 15 is provided in the intake passage 11. Fuel is injected into the intake passage 11 through drive control over the fuel injection valve 15 (fuel injection control).

In the combustion chamber 14 of the internal combustion engine 10, air-fuel mixture formed of intake air and injected fuel is ignited by an ignition plug 16. The air-fuel mixture burns because of the ignition operation to cause a piston 17 to reciprocate, and a crankshaft 18 rotates. Then, burned air-fuel mixture is discharged from the combustion chamber 14 to an exhaust passage 19 as exhaust gas, and is purified by a three-way catalyst provided in the exhaust passage 19 (hereinafter, exhaust gas purification catalyst 20), and is then emitted outside.

Note that the exhaust gas purification catalyst 20 has the function of purifying exhaust gas by oxidizing hydrocarbons (HC) and carbon monoxide (CO) in the exhaust gas and reducing nitrogen oxides (NOx) in the exhaust gas in a state where air-fuel mixture is burned near a stoichiometric air-fuel ratio. In addition, the exhaust gas purification catalyst 20 has an oxygen storage function of storing oxygen contained in exhaust gas passing through the exhaust gas purification catalyst 20 when the oxygen concentration of the exhaust gas is a concentration during engine operation in a state where the air-fuel ratio of air-fuel mixture is lean and releasing oxygen when the oxygen concentration is a concentration during engine operation in a state where the air-fuel ratio of air-fuel mixture is rich.

The apparatus according to the present embodiment includes various sensors for detecting the operating state of the internal combustion engine 10. Such various sensors, for example, include a crank sensor 31 and an intake air flow rate sensor 32. The crank sensor 31 is used to detect the rotational speed of the crankshaft 18 (engine rotational speed NE). The intake air flow rate sensor 32 is used to detect the flow rate of intake air that passes through the intake passage 11 (passage intake air flow rate GA). In addition, such various sensors include an accelerator sensor 33, a throttle sensor 34 and a coolant temperature sensor 35. The accelerator sensor 33 is used to detect the depression amount AC of an accelerator pedal (not shown). The throttle sensor 34 is used to detect the throttle opening degree TA. The coolant temperature sensor 35 is used to detect the temperature (THW) of coolant. Furthermore, such various sensors include an air-fuel ratio sensor 36, an oxygen sensor 37, and the like. The air-fuel ratio sensor 36 outputs a signal corresponding to the oxygen concentration of exhaust gas in the exhaust passage 19 at a portion upstream of the exhaust gas purification catalyst 20 (specifically, an exhaust manifold). The oxygen sensor 37 outputs a signal corresponding to the oxygen concentration of exhaust gas in the exhaust passage 19 at a portion downstream of the exhaust gas purification catalyst 20. Other than the above, such various sensors include an operation switch 38, and the like. The operation switch 38 is turned on when the operation of the internal combustion engine 10 is started; whereas the operation switch 38 is turned off when the operation of the internal combustion engine 10 is stopped.

Note that the air-fuel ratio sensor 36 is a known limiting current oxygen sensor. The limiting current oxygen sensor includes a ceramic layer called diffusion-controlling layer at a detecting portion of a concentration cell oxygen sensor to thereby make it possible to obtain an output current corresponding to the oxygen concentration in exhaust gas. The output current of the limiting current oxygen sensor is “0” when the air-fuel ratio of air-fuel mixture, which is in close relationship with the oxygen concentration in exhaust gas, is a stoichiometric air-fuel ratio. In addition, the output current increases in a negative direction as the air-fuel ratio of air-fuel mixture becomes richer; the output current increases in a positive direction as the air-fuel ratio becomes leaner. Thus, the degree of leanness or richness of the air-fuel ratio of air-fuel mixture may be detected on the basis of the output signal of the air-fuel ratio sensor 36.

In addition, the oxygen sensor 37 is a known concentration cell oxygen sensor. The output voltage of about 1 volt is obtained from the concentration cell oxygen sensor when the oxygen concentration of exhaust gas is a concentration at the time when the air-fuel ratio of air-fuel mixture is richer than the stoichiometric air-fuel ratio. The output voltage of about 0 volts is obtained from the concentration cell oxygen sensor when the oxygen concentration of exhaust gas is a concentration at the time when the air-fuel ratio of air-fuel mixture is leaner than the stoichiometric air-fuel ratio. In addition, the output voltage of the concentration cell oxygen sensor significantly varies when the oxygen concentration of exhaust gas is a concentration at the time when the air-fuel ratio of air-fuel mixture is around the stoichiometric air-fuel ratio. Thus, on the basis of the above output signal of the oxygen sensor 37, it is possible to detect whether exhaust gas downstream of the exhaust gas purification catalyst 20 has lean properties or rich properties.

The oxygen sensor 37 is provided downstream of the exhaust gas purification catalyst 20 in order to monitor the condition of the exhaust gas purification action in the exhaust gas purification catalyst 20. That is, in a state where exhaust gas upstream of the exhaust gas purification catalyst 20 is excessively lean, even when oxygen consumption or oxygen storage owing to oxidation action occurs in the exhaust gas purification catalyst 20, redundant oxygen is discharged to the downstream side of the exhaust gas purification catalyst 20 and then the output signal of the oxygen sensor 37 becomes a value corresponding to a lean air-fuel ratio. On the other hand, when the oxidation action in the exhaust gas purification catalyst 20 is facilitated and oxygen in exhaust gas is consumed, the output signal of the oxygen sensor 37 becomes a value corresponding to a rich air-fuel ratio. The condition of the exhaust gas purification action is monitored on the basis of the above detected result of the oxygen sensor 37.

The apparatus according to the present embodiment, for example, includes an electronic control unit 30 that includes a microcomputer. The electronic control unit 30 acquires detected signals of various sensors and computes various computations to execute various controls, such as throttle control, fuel injection control and ignition timing control, on the basis of the computation results.

The electronic control unit 30 includes a volatile memory (RAM 30a). Then, the electronic control unit 30 and the RAM 30a are supplied with electric power from a battery 21. Detected results of the various sensors and results of the computations are temporarily stored in the RAM 30a. Note that supply of electric power from the battery 21 to the RAM 30a is maintained irrespective of the operating state of the operation switch 38. By so doing, even when the operation switch 38 is turned off in order to stop the operation of the internal combustion engine 10, data stored in the RAM 30a of the electronic control unit 30 are held and stored. However, when supply of electric power to the RAM 30a is temporarily stopped because of replacement of the battery 21, or the like, data (specifically, an oxygen storage capacity Cf and a weighted average value AVCf, which will be described later) stored in the RAM 30a are lost and are changed to initial values.

In the present embodiment, the amount of air taken into the combustion chamber 14 (cylinder intake air amount) is adjusted as follows. That is, first, a control target value of the cylinder intake air amount (target cylinder intake air amount Tga) is calculated on the basis of the depression amount AC of the accelerator pedal and the engine rotational speed NE. Then, a value corresponding to the throttle opening degree TA at which the target cylinder intake air amount Tga coincides with an actual cylinder intake air amount is calculated as a target throttle opening degree Tta, and throttle control is executed so that the target throttle opening degree Tta coincides with the actual throttle opening degree TA.

On the other hand, in fuel injection control according to the present embodiment, a fuel amount (target fuel injection amount TQ) at which the air-fuel ratio of air-fuel mixture becomes a target air-fuel ratio (basically, stoichiometric air-fuel ratio) is obtained on the basis of the passage intake air flow rate GA, and the fuel injection valve 15 is controlled so that an actual fuel injection amount Q coincides with the target fuel injection amount TQ.

In addition, in the present embodiment, control, so-called air-fuel ratio feedback control, is executed in such a manner that a feedback correction amount is calculated on the basis of the degree of deviation between an actual oxygen concentration of exhaust gas, detected by the air-fuel ratio sensor 36, and a desired concentration (for example, an exhaust gas oxygen concentration at which the air-fuel ratio of air-fuel mixture is the stoichiometric air-fuel ratio) and then the target fuel injection amount TQ is corrected on the basis of the feedback correction amount.

The reason why such air-fuel ratio feedback control is executed is because of the following reason. The exhaust gas purification catalyst 20 efficiently purifies all the major toxic substances (HC, CO, NOx) in exhaust gas through oxidation-reduction reaction only when the air-fuel ratio of air-fuel mixture to be burned falls within a narrow range (so-called window) around the stoichiometric air-fuel ratio. Therefore, in order to cause the exhaust gas purification catalyst 20 to effectively exhibit the exhaust gas purification action, it is necessary to strictly adjust the fuel injection amount so as to bring the air-fuel ratio of air-fuel mixture into coincidence with the center of the window.

In the present embodiment, the oxygen storage capability (specifically, the storable amount of oxygen “oxygen storage capacity”) of the exhaust gas purification catalyst 20 is obtained as an index value for acquiring the degree of degradation of the exhaust gas purification catalyst 20. Note that, as described above, the exhaust gas purification catalyst 20 has an oxygen storage function, and the oxygen storage capacity tends to reduce as the degradation of the exhaust gas purification catalyst 20 advances, so, in the present embodiment, the oxygen storage capacity is obtained as an index value of the degree of degradation of the exhaust gas purification catalyst 20. The oxygen storage capacity is specifically obtained as follows.

That is, first, when the output signal of the oxygen sensor 37 varies from a value indicating a lean air-fuel ratio to a value indicating a rich air-fuel ratio (or varies from a value indicating a rich air-fuel ratio to a value indicating a lean air-fuel ratio), control (active control) for changing the control target value of the air-fuel ratio of air-fuel mixture (target air-fuel ratio TAF) from a value corresponding to a rich air-fuel ratio to a value corresponding to a lean air-fuel ratio (or from a value corresponding to a lean air-fuel ratio to a value corresponding to a rich air-fuel ratio) is started.

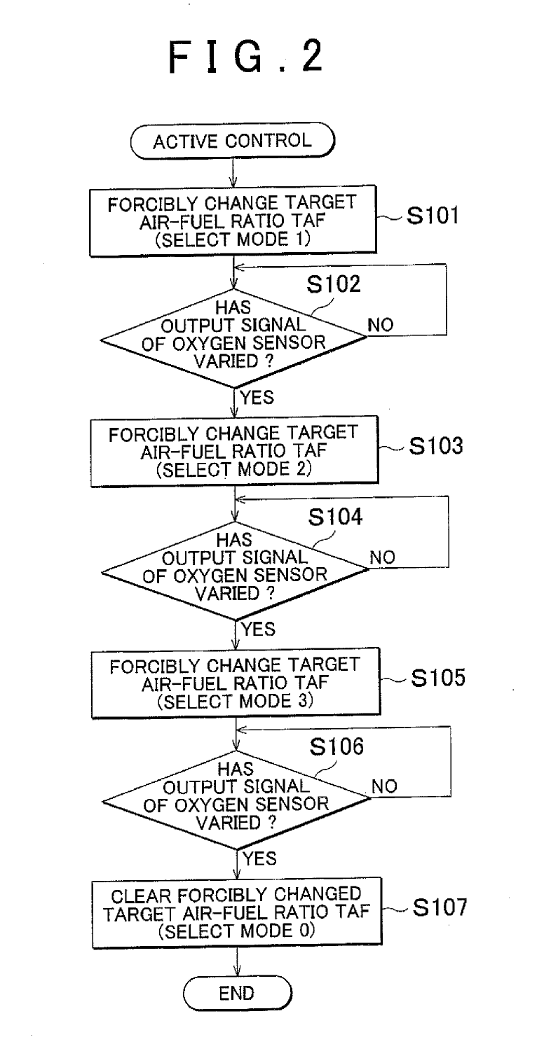

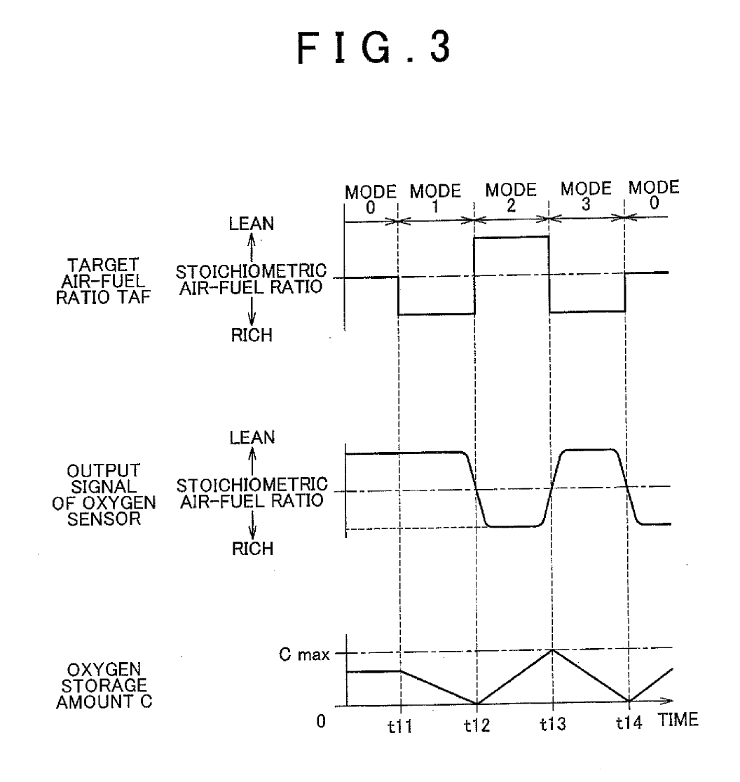

FIG. 2 is a flowchart that shows the procedure executed in active control. FIG. 3 is a timing chart that shows a variation in the target air-fuel ratio TAF, a variation in the output signal of the oxygen sensor 37 and a variation in the oxygen storage amount C of the exhaust gas purification catalyst 20 when the active control is executed.

As shown in FIG. 2, when active control is started, “Mode 1” is initially selected, and the target air-fuel ratio TAF is forcibly changed (step S101). Here, when the output signal of the oxygen sensor 37 is a value indicating a rich air-fuel ratio, the target air-fuel ratio TAF is changed to a predetermined ratio that is leaner than the stoichiometric air-fuel ratio; whereas, when the output signal of the oxygen sensor 37 is a value indicating a lean air-fuel ratio, the target air-fuel ratio TAF is changed to a predetermined ratio that is richer than the stoichiometric air-fuel ratio.

In the example shown in FIG. 3, because the output signal of the oxygen sensor 37 is a value indicating a lean air-fuel ratio at the time when active control is started (time t11), the target air-fuel ratio TAF at this time is forcibly changed to a ratio that is richer than the stoichiometric air-fuel ratio. By so doing, the fuel injection amount Q is increased thereafter and then the air-fuel ratio of air-fuel mixture becomes rich.

Then, immediately after the air-fuel ratio of air-fuel mixture becomes rich, oxygen is released from the exhaust gas purification catalyst 20, so the output signal of the oxygen sensor 37 becomes a value corresponding to a lean air-fuel ratio. After that, when oxygen stored in the exhaust gas purification catalyst 20 is totally released and then release of oxygen from the exhaust gas purification catalyst 20 is stopped, the output signal of the oxygen sensor 37 becomes a value corresponding to a rich air-fuel ratio (after time t12). Because the output signal of the oxygen sensor 37 varies from a value indicating a lean air-fuel ratio to a value indicating a rich air-fuel ratio, it may be determined that oxygen stored in the exhaust gas purification catalyst 20 is totally released and then the oxygen storage amount C is “0”.

In this way, when the output signal of the oxygen sensor 37 varies at the time when “Mode 1” is selected (YES in step S102 of FIG. 2), “Mode 2” is selected and the target air-fuel ratio TAF is forcibly changed (step S103). Here, when the target air-fuel ratio TAF at the time when “Mode 1” is selected is a rich air-fuel ratio, the target air-fuel ratio TAF is forcibly changed to a predetermined lean air-fuel ratio; whereas, when the target air-fuel ratio TAF at the time when “Mode 1” is selected is a lean air-fuel ratio, the target air-fuel ratio TAF is forcibly changed to a predetermined rich air-fuel ratio.

In the example shown in FIG. 3, because the target air-fuel ratio TAF at the time when “Mode 1” is selected (from time t11 to time t12) is a rich air-fuel ratio, the target air-fuel ratio TAF at this time is forcibly changed to the predetermined lean air-fuel ratio. By so doing, the fuel injection amount Q is reduced thereafter and then the air-fuel ratio of air-fuel mixture becomes lean.

Then, immediately after the air-fuel ratio of air-fuel mixture becomes lean, oxygen is stored into the exhaust gas purification catalyst 20, so the output signal of the oxygen sensor 37 becomes a value corresponding to a rich air-fuel ratio. After that, when storage of oxygen into the exhaust gas purification catalyst 20 reaches a limit, oxygen in exhaust gas is not stored into the exhaust gas purification catalyst 20 anymore, so the output signal of the oxygen sensor 37 becomes a value indicating a lean air-fuel ratio (after time t13). Because the output signal of the oxygen sensor 37 varies from a value indicating a rich air-fuel ratio to a value indicating a lean air-fuel ratio in this way, it appears that the oxygen storage amount C of the exhaust gas purification catalyst 20 has reached a limit amount (maximum oxygen storage amount Cmax).

When the output signal of the oxygen sensor 37 at the time when “Mode 2” is selected varies in this way (YES in step S104 of FIG. 2), “Mode 3” is selected, and the target air-fuel ratio TAF is forcibly changed (step S105). Here, when the target air-fuel ratio TAF at the time when “Mode 2” is selected is a rich air-fuel ratio, the target air-fuel ratio TAF is forcibly changed to the predetermined lean air-fuel ratio; whereas, when the target air-fuel ratio TAF at the time when “Mode 2” is selected is a lean air-fuel ratio, the target air-fuel ratio TAF is forcibly changed to the predetermined rich air-fuel ratio.

In the example shown in FIG. 3, because the target air-fuel ratio TAF at the time when “Mode 2” is selected (from time t12 to time t13) is a lean air-fuel ratio, the target air-fuel ratio TAF at this time is forcibly changed to the predetermined rich air-fuel ratio. Then, immediately after the air-fuel ratio of air-fuel mixture becomes rich, oxygen is released from the exhaust gas purification catalyst 20, so the output signal of the oxygen sensor 37 becomes a value indicating a lean air-fuel ratio. Then, when oxygen stored in the exhaust gas purification catalyst 20 is totally released, the output signal of the oxygen sensor 37 becomes a value indicating a rich air-fuel ratio (after time t14). Because the output signal of the oxygen sensor 37 varies from a value indicating a lean air-fuel ratio to a value indicating a rich air-fuel ratio, it may be determined that oxygen stored in the exhaust gas purification catalyst 20, that is, the maximum oxygen storage amount Cmax, has been totally released.

When the output signal of the oxygen sensor 37 at the time when “Mode 3” is selected varies in this way (YES in step S106 of FIG. 2), “Mode 0” is selected. By so doing, the forcibly changed target air-fuel ratio TAF is cleared (step S107), and then active control is stopped.

In this way, in active control, the air-fuel ratio of air-fuel mixture is forcibly changed on the basis of the output signal of the oxygen sensor 37. Then, on the basis of a mode of variation in oxygen concentration of exhaust gas downstream of the exhaust gas purification catalyst 20 (specifically, the output signal of the oxygen sensor 37) during active control as described above, it is possible to recognize the state where the oxygen storage amount C of the exhaust gas purification catalyst 20 is “0” or the state where the oxygen storage amount C has reached the maximum oxygen storage amount Cmax.

Specifically, the amount of oxygen flowing into the exhaust gas purification catalyst 20 in a period during which the air-fuel ratio of air-fuel mixture is lean and the output signal of the oxygen sensor 37 is a value indicating a rich air-fuel ratio (in the example shown in FIG. 3, a period during which “Mode 2” is selected) is accumulated to thereby make it possible to estimate the oxygen storage capacity of the exhaust gas purification catalyst 20. In addition, the amount of oxygen released from the exhaust gas purification catalyst 20 in a period during which the air-fuel ratio of air-fuel mixture is lean and the output signal of the oxygen sensor 37 is a value indicating a rich air-fuel ratio (in the example shown in FIG. 3, a period during which “Mode 3” is selected) is accumulated to thereby make it possible to estimate the amount of oxygen that may be released from the exhaust gas purification catalyst 20 (oxygen release capacity). Note that oxygen released from the exhaust gas purification catalyst 20 is oxygen originally stored in the exhaust gas purification catalyst 20, so the oxygen release capacity becomes a value approximately equal to the oxygen storage capacity and becomes a value that substantially indicates the oxygen storage capacity.

In consideration of this point, in the present embodiment, the oxygen storage capacity and the oxygen release capacity calculated during active control are detected as an estimated oxygen storage capacity (hereinafter, “oxygen storage capacity Cf”) of the exhaust gas purification catalyst 20.

Note that, in the present embodiment, a detecting condition that includes a logical multiplication condition formed of the following conditions is set and the oxygen storage capacity Cf is detected on the condition that the above detecting condition is satisfied.
A variation per unit time in the intake air amount (specifically, the passage intake air flow rate GA) of the internal combustion engine 10 is small.
The temperature of the exhaust gas purification catalyst 20 is somewhat high.
Warm-up of the internal combustion engine 10 is compete (specifically, the temperature THW of coolant is higher than or equal to a predetermined temperature “for example, 80° C.”).

Process of detecting the oxygen storage capacity Cf (detecting process) is executed by the electronic control unit 30 as interruption process at predetermined intervals. In the present embodiment, the exhaust gas purification catalyst 20 functions as an evaluation target device, the oxygen storage capacity. Cf functions as a state quantity that correlates with the operating state of the evaluation target device, and the electronic control unit 30 functions as a detecting unit that repeatedly detects the state quantity at time intervals.

Then, in the apparatus according to the present embodiment, it is determined whether there is a degradation abnormality in the exhaust gas purification catalyst 20 on the basis of the above detected oxygen storage capacity Cf. Specifically, first, where the weighted average value calculated at the previous calculation timing is AVCf[i], the weighted average value AVCf is calculated from the following relational expression (1) each time the oxygen storage capacity Cf has been detected. In the present embodiment, data are accumulated one by one each time the weighted average value AVCf is calculated in this way.

AVCf=(AVCf[i]×N+Cf)/(N+1) (1)

In the above mathematical expression, N is a positive number (in the present embodiment, “1”).

Then, the thus calculated weighted average value AVCf is compared with a predetermined degradation determination value J. Specifically, when the weighted average value AVCf is smaller than or equal to the degradation determination value J (AVCf≦J), the oxygen storage capacity is small, so it is highly likely that degradation of the exhaust gas purification catalyst 20 at this time has advanced and then it is determined that there is a degradation abnormality. On the other hand, when the weighted average value AVCf is larger than the degradation determination value J (AVCf>J), the oxygen storage amount is relatively large, so degradation of the exhaust gas purification catalyst 20 has not advanced significantly and then it is determined that there is no degradation abnormality.

Note that process of determining whether there is a degradation abnormality in the exhaust gas purification catalyst 20 (determining process) is also executed by the electronic control unit 30 as interruption process at predetermined intervals as in the case of the above described detecting process. In addition, the degradation determination value J, by which it is possible to accurately determine whether there is a degradation abnormality in the exhaust gas purification catalyst 20, is obtained in advance on the basis of the results of experiment or simulation and is stored in the electronic control unit 30. In the present embodiment, the electronic control unit 30 functions as a determining unit that determines whether there is an abnormality on the basis of multiple pieces of data (specifically, the oxygen storage capacities Cf) detected through the detecting process and stored.

Here, in the apparatus according to the present embodiment, the weighted average value AVCf of the oxygen storage capacities Cf is calculated, and abnormality determination is executed on the basis of the weighted average value AVCf. When a certain number of stored oxygen storage capacities Cf are ensured, the weighted average value AVCf becomes consistent with an actual operating state of the exhaust gas purification catalyst 20. Therefore, in the present embodiment, when a certain number of stored oxygen storage capacities Cf are ensured, abnormality determination may be executed with high accuracy.

Incidentally, in the apparatus according to the present embodiment, when supply of electric power to the electronic control unit 30 (specifically, the RAM 30a) is temporarily interrupted by replacement of the battery 21, stored data (specifically, the oxygen storage capacities Cf and the weighted average value AVCf) stored in the RAM 30a become initial values. Therefore, during a period thereafter until the oxygen storage capacity Cf is repeatedly detected and stored and then a certain number of stored oxygen storage capacities Cf are ensured, the accuracy of abnormality determination deteriorates because the weighted average value AVCf is not consistent with an actual operating state of the exhaust gas purification catalyst 20.

Such deterioration in determination accuracy may be avoided by prohibiting abnormality determination over a period from when data are accidentally initialized until the number of stored oxygen storage capacities Cf reaches a certain value. However, in this case, the timing at which it is determined whether there is an abnormality delays by a certain period of time during which abnormality determination cannot be executed, so it is not desirable.

In consideration of this point, in the present embodiment, when stored data (specifically, the oxygen storage capacities Cf and the weighted average value AVCf) stored in the RAM 30a become initial values (so-called when the RAM 30a is cleared by disconnecting the battery), the number of stored oxygen storage capacities Cf thereafter is counted, and abnormality determination is permitted or prohibited on the basis of the number of stored oxygen storage capacities Cf. In the apparatus according to the present embodiment, the situation that no data are stored is determined because of the fact that supply of electric power from the battery 21 to the RAM 30a is temporarily stopped by replacement of the battery 21, specifically, stored data are initialized.

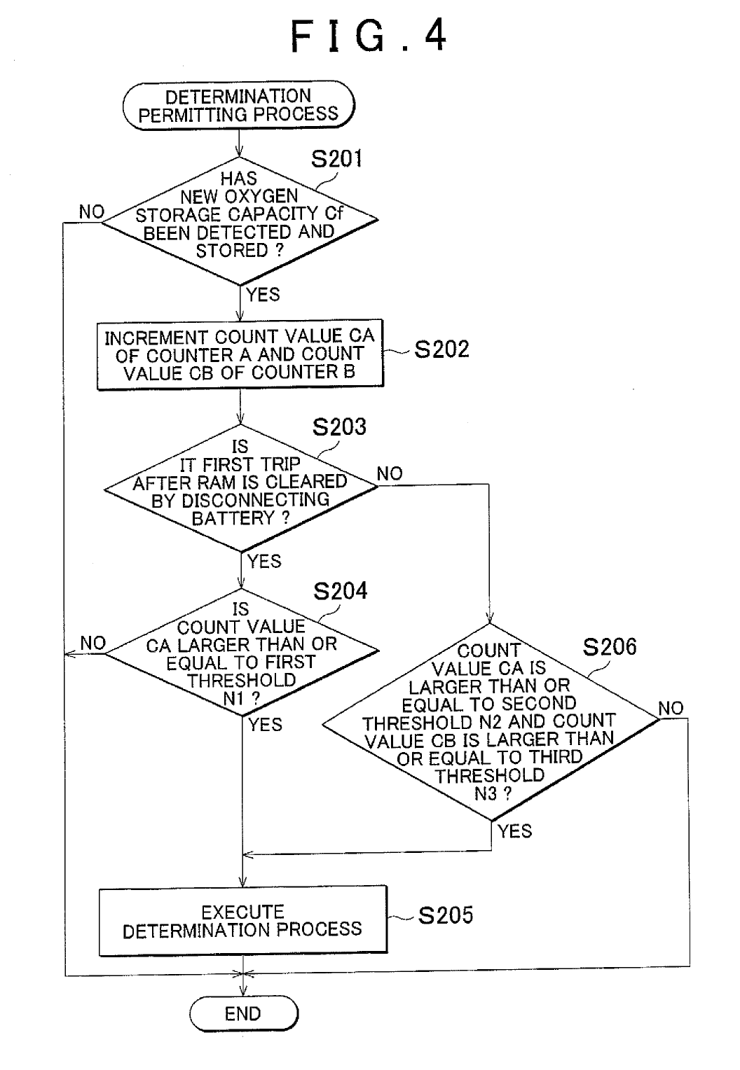

Hereinafter, process of permitting abnormality determination on the basis of the number of the stored oxygen storage capacities Cf (determination permitting process) will be described in detail with reference to FIG. 4. FIG. 4 is a flowchart that shows the procedure executed in the determination permitting process. A series of processes shown in the flowchart of the drawing are executed by the electronic control unit 30 as interruption process at predetermined intervals.

As shown in FIG. 4, in this process, first, it is determined whether a new oxygen storage capacity Cf is detected and stored through the above described detecting process (step S201). Then, when no new oxygen storage capacity Cf is detected or stored (NO in step S201), the process once ends without executing the following processes.

On the other hand, when a new oxygen storage capacity Cf is detected and stored (YES in step S201), the count value CA of a counter A and the count value CB of a counter B both are incremented (step S202).

The count value CA of the counter A is reset to “0” when stored data (specifically, the weighted average value AVCf) becomes an initial, value. The number of stored oxygen storage capacities Cf after supply of electric power from the battery 21 to the RAM 30a is temporarily interrupted is counted by the counter A. That is, the count value CA corresponds to the number of stored oxygen storage capacities Cf after supply of electric power from the battery 21 to the RAM 30a is temporarily interrupted. In the present embodiment, the number counted as the count value CA functions as a total storage number.

In addition, the count value CB of the counter B is reset to “0” when the operation switch 38 is turned on. The number of stored oxygen storage capacities Cf after the operation of the internal combustion engine 10 is started is counted by the counter B. That is, the count value CB corresponds to the number of stored oxygen storage capacities Cf after the operation of the internal combustion engine 10 is started. In the present embodiment, the number counted as the count value CB functions as a periodical storage number.

After the count values CA and CB are incremented in this way, it is determined whether it is the first trip after the RAM 30a is cleared by disconnecting the battery (step S203). Here, during a period from when the weighted average value AVCf becomes an initial value to when the operation switch 38 is turned off, it is determined that it is the first trip after the RAM 30a is cleared by disconnecting the battery. Note that the trip is a period from when the operation switch 38 is turned on to start the internal combustion engine 10 to when the operation switch 38 is turned off to stop the internal combustion engine 10. In addition, other than the counters A and B, a counter D is set in the electronic control unit 30. The count value CD of the counter D is reset to “0” when the weighted average value AVCf becomes an initial value, and is incremented each time the operation switch 38 is turned off. In the process of step S203, when the count value CD of the counter D is “0”, it is determined that it is the first trip after the RAM 30a is cleared by disconnecting the battery.

Then, when it is the first trip after the RAM 30a is cleared by disconnecting the battery (YES in step S203), on the condition that the count value CA of the counter A is larger than or equal to a first threshold N1 (for example, “8”) (YES in step S204), the above described determining process based on the weighted average value AVCf is executed (step S205).

On the other hand, when the count value CA of the counter A is smaller than the first threshold N1 (NO in step S204), abnormality determination based on the weighted average value AVCf is not executed (the process of step S205 is jumped).

Note that the number of stored oxygen storage capacities Cf after the weighted average value AVCf accidentally becomes an initial value and that is sufficient to execute abnormality determination based on the weighted average value AVCf with high accuracy is obtained in advance on the basis of the results of experiment or simulation and is stored in the electronic control unit 30 as the first threshold N1.

In the apparatus according to the present embodiment, when the weighted average value AVCf accidentally becomes an initial value, on the condition that a large number (first threshold N1) of new oxygen storage capacities Cf are detected and stored for a certain period of time thereafter (specifically, during the first trip immediately after the accidental initialization), that is, after the weighted average value AVCf sufficiently varies in consistent with an actual operating state of the exhaust gas purification catalyst 20, abnormality determination based on the weighted average value AVCf is executed. Thus, although data used to calculate the weighted average value AVCf include data having low reliability (initial value), abnormality determination is executed after a number of new data (oxygen storage capacities Cf) sufficient to obtain high determination accuracy are detected and stored, so the determination may be executed with high accuracy.

In addition, when it is not the first trip after the RAM 30a is cleared by disconnecting the battery (NO in step S203), on the condition that the count value CA of the counter A is larger than or equal to a second threshold N2 (for example, “4”) and the count value CB of the counter B is larger than or equal to a third threshold N3 (for example, “2”) (YES in step S206), abnormality determination based on the weighted average value AVCf is executed (step S205).

Note that the number of stored oxygen storage capacities Cf after the weighted average value AVCf accidentally becomes an initial value and that is minimally required to maintain the determination accuracy of abnormality determination based on the weighted average value AVCf is obtained in advance on the basis of the results of experiment or simulation and is stored in the electronic control unit 30 as the second threshold N2. The second threshold N2 is smaller than the first threshold N1.

In addition, the number of stored oxygen storage capacities Cf after the operation switch 38 is turned on and that is able to ensure the frequency of abnormality determination and also to appropriately incorporate the latest oxygen storage capacities Cf into abnormality determination is obtained in advance on the basis of the results of experiment or simulation and is stored in the electronic control unit 30 as the third threshold N3. The third threshold N3 is smaller than the first threshold N1 and the second threshold N2.

On the other hand, when the count value CA of the counter A is smaller than the second threshold N2 or when the count value CB of the counter B is smaller than the third threshold N3 (NO in step S206), abnormality determination based on the weighted average value AVCf is not executed (the process of step S205 is jumped).

In the present embodiment, in the second trip or later after the weighted average value AVCf accidentally becomes an initial value, on the condition that a relatively small number (number corresponding to the second threshold N2) of new oxygen storage capacities Cf are detected and stored after the weighted average value AVCf becomes an initial value, that is, at the timing at which the weighted average value AVCf has varied to a minimally required degree to maintain determination accuracy, abnormality determination is executed.

By so doing, it is possible to execute abnormality determination based on the weighted average value AVCf on the condition that a number of new oxygen storage capacities Cf that are minimally required to maintain determination accuracy are detected and stored, so it is possible to avoid an unnecessary delay of the timing at which determination result is obtained while suppressing deterioration in determination accuracy.

Note that, in the present embodiment, active control is executed when the oxygen storage capacity Cf is detected. When the active control is executed, because the air-fuel ratio of air-fuel mixture is forcibly changed, it may cause deterioration in exhaust gas properties. Therefore, when a period of time taken to execute abnormality determination increases, deterioration in exhaust gas properties easily occurs accordingly. In terms of this point, in the apparatus according to the present embodiment, it is possible to reduce a period of time during which abnormality determination is executed, so it is possible to suppress deterioration in exhaust gas properties accordingly.

In addition, degradation abnormality of the exhaust gas purification catalyst 20 is early determined and then, for example, it is possible to early take measures against the degradation abnormality, such as replacement of the exhaust gas purification catalyst 20, so it is possible to suppress deterioration in exhaust gas properties due to the degradation abnormality.

Furthermore, in the present embodiment, in the second trip or later after the weighted average value AVCf accidentally becomes an initial value, on the condition that, in addition to the fact that the count value CA is larger than or equal to the second threshold N2, the count value CB is larger than or equal to the third threshold N3, that is, new oxygen storage capacities Cf of which the number is larger than or equal to “N3” are detected and stored after the operation switch 38 is turned on, abnormality determination based on the weighted average value AVCf is executed. By so doing, it is possible to execute abnormality determination on the basis of the weighted average value AVCf calculated on the basis of data that include the latest data of which the number is larger than or equal to “N3” (specifically, the oxygen storage capacities Cf detected and stored after the operation switch 38 is turned on last). Therefore, it is possible to accurately execute abnormality determination in consistent with an actual operating state of the exhaust gas purification catalyst 20.

By executing the above determination permitting process, the following function may be obtained. That is, when the weighted average value AVCf accidentally becomes an initial value at the time of replacement of the battery 21, or the like, first, on the condition that the number of stored oxygen storage capacities Cf is sufficiently ensured, that is, importance is placed on high determination accuracy, abnormality determination is executed. Therefore, in this case, abnormality determination may be executed with high accuracy. Moreover, when the operation switch 38 is turned off before the number of stored oxygen storage capacities Cf reaches a sufficient number, on the condition that a relatively small number of oxygen storage capacities Cf are detected and stored thereafter, that is, importance is placed on early completion of abnormality determination, the abnormality determination is executed. Therefore, it is possible to avoid an unnecessary delay of the timing at which determination result is obtained while suppressing deterioration in determination accuracy.

As described above, according to the present embodiment, the following advantageous effects may be obtained.

(1) When the weighted average value AVCf accidentally becomes an initial value, abnormality determination based on the weighted average value AVCf is executed in the first trip immediately after the accidental initialization on the condition that a large number of new oxygen storage capacities Cf are detected and stored. Therefore, although data used to calculate the weighted average value AVCf include data having low reliability, abnormality determination may be executed after a sufficient number of new data for obtaining high determination accuracy are detected and stored, so it is possible to execute the determination with high accuracy. Moreover, in the second trip or later after the weighted average value AVCf accidentally becomes an initial value, abnormality determination is executed on the condition that a relatively small number of new oxygen storage capacities Cf are detected and stored after the weighted average value AVCf becomes an initial value. Therefore, on the condition that a number of new oxygen storage capacities Cf that are minimally required to maintain determination accuracy are detected and stored, abnormality determination based on the weighted average value AVCf may be executed, so it is possible to avoid an unnecessary delay of the timing at which determination result is obtained while suppressing deterioration in determination accuracy. Thus, it is possible to execute abnormality determination with high accuracy and quickly execute abnormality determination.

(2) In the second trip or later after the weighted average value AVCf accidentally becomes an initial value, on the condition that, in addition to the fact that the count value CA is larger than or equal to the second threshold N2, the count value CB is larger than or equal to the third threshold N3, abnormality determination based on the weighted average value AVCf is executed. By so doing, it is possible to execute abnormality determination on the basis of the weighted average value AVCf calculated on the basis of data that include the latest data of which the number is larger than or equal to “N3”, so it is possible to accurately execute abnormality determination in consistent with an actual operating state of the exhaust gas purification catalyst 20.

(3) The embodiment is applied to the apparatus that calculates the weighted average value AVCf each time an oxygen storage capacity Cf is detected and stored and that determines whether there is an abnormality through a comparison between the weighted average value AVCf and the degradation determination value J. Therefore, when the weighted average value AVCf accidentally becomes an initial value, after the weighted average value AVCf sufficiently varies in consistent with an actual operating state of the exhaust gas purification catalyst 20 for a certain period of time, abnormality determination may be executed, so it is possible to execute the determination with high accuracy. Moreover, in the second trip or later after the weighted average value AVCf accidentally becomes an initial value, abnormality determination may be executed at the timing at which the weighted average value AVCf has varied to a minimally required degree to maintain determination accuracy, so it is possible to avoid an unnecessary delay of the timing at which determination result is obtained while suppressing deterioration in determination accuracy.

Note that the above embodiment may be implemented in the following alternative embodiments.
When the weighted average value AVCf is accidentally initialized, the condition for detecting an oxygen storage capacity Cf may be loosened for a certain period of time thereafter (for example, while the operation switch 38 is repeatedly turned on and off several times). Such loosening of the detecting condition may be, for example, implemented in such a manner that the detecting condition is changed to a condition that it is permitted to detect the oxygen storage capacity Cf even when a variation per, unit time of the intake air flow rate of the internal combustion engine 10 is slightly large or the detecting condition is changed to a condition that it is permitted to detect the oxygen storage capacity Cf even when the temperature of the exhaust gas purification catalyst 20 is slightly low. With the above configuration, it is possible to increase the detection frequency of the oxygen storage capacity Cf through loosening the detecting condition. By so doing, the rates of increase in the count values CA and CB of the counters A and B may be increased, so abnormality determination based on the weighted average value AVCf may be early executed.
In the process of step S206 of FIG. 4, the condition that the count value CB of the counter B is larger than or equal to the third threshold N3 may be omitted. That is, determining process may be executed only on the condition that the count value CA of the counter A is larger than or equal to the second threshold N2.
In the above embodiment, the situation that no data are stored in the RAM 30a of the electronic control unit 30, specifically, the RAM 30a is cleared by disconnecting the battery, is determined because of the fact that the count value CD of the counter D is “0”. However, the aspect of the invention is not limited to this configuration. The situation that no data are stored in the RAM 30a may be determined because of the fact that the count value CA of the counter A is “0” or data stored in the RAM 30a of the electronic control unit 30 are initial values.
Instead of calculating the weighted average value AVCf on the basis of the relational expression (1), it is also applicable that the latest value is calculated from the relational expression “Latest value=Value[i]−(Value[i]−Cf)×N” where a value calculated at the time of previous calculation process is [i] and a predetermined positive number is N (0<N<1) or the average of a plurality of the most recent oxygen storage capacities Cf detected is calculated. In short, it is only necessary to be able to calculate a value that indicates the tendency of variation in oxygen storage capacity Cf.
The above embodiment may be applied to not only an apparatus that determines whether there is an abnormality on the basis of a value calculated on the basis of a plurality of oxygen storage capacities Cf (specifically, the weighted average value AVCf) but also an apparatus that determines whether there is an abnormality on the basis of the plurality of oxygen storage capacities Cf themselves with an appropriately modified configuration. Such an apparatus may be for example, an apparatus that each time an oxygen storage capacity Cf is detected and stored, executes temporary determination as to whether there is an abnormality through a comparison between the oxygen storage capacity Cf and a predetermined determination value and then determines that there is an abnormality because of the fact that the percentage of determination that there is an abnormality among a plurality of the most recent results of temporary determination is higher than or equal to a predetermined value or the number of determinations that there is an abnormality is larger than or equal to a predetermined number.
The aspect of the invention may also be applied to an abnormality determination apparatus that determines whether there is an abnormality in an evaluation target device other than the exhaust gas purification catalyst as long as the apparatus repeatedly detects and stores a state quantity, which correlates with the operating state of the evaluation target device, at time intervals and then determines whether there is an abnormality in the evaluation target device on the basis of those multiple pieces of stored data. Such an apparatus may be, for example, an apparatus described in the following “Apparatus 1” or an apparatus described in “Apparatus 2”.
   [Apparatus 1] An abnormality determination apparatus that employs an air-fuel ratio sensor as an evaluation target device and that employs a variation speed in exhaust gas oxygen concentration, which is detected and stored by the air-fuel ratio sensor as a state quantity that correlates with an operating state of the evaluation target device, to determine whether there is a degradation abnormality in the air-fuel ratio sensor on the basis of a plurality of the variation speeds in exhaust gas oxygen concentration.
   [Apparatus 2] An abnormality determination apparatus that employs a fuel injection valve as an evaluation target device and that employs a steady deviation between an exhaust gas oxygen concentration, which is detected and stored by an air-fuel ratio sensor as a state quantity that correlates with an operating state of the evaluation target device, and a reference value (a value corresponding to a stoichiometric air-fuel ratio) to determine whether there is a deposit adhesion abnormality of the fuel injection valve on the basis of a plurality of the deviations.

An abnormality determination apparatus according to the aspect of the invention will be described below again. The abnormality determination apparatus includes: a detecting unit that repeatedly detects a state quantity, which correlates with an operating state of an evaluation target device, at time intervals; and a determining unit that determines whether there is an abnormality on the basis of multiple pieces of data detected by the detecting unit and stored. The abnormality determination apparatus counts the number of the stored data as a total storage number after there occurs a situation that no data are stored, permits the determining unit to execute abnormality determination on the condition that the total storage number has reached a first threshold in a first trip after the situation occurs, and permits the determining unit to execute abnormality determination on the condition that the total storage number has reached a second threshold that is smaller than the first threshold in a second trip or later after the situation occurs.

Note that the trip is a period from when an internal combustion engine is started to when the internal combustion engine is stopped. In the abnormality determination apparatus, in the second trip or later, the abnormality determination apparatus may count the number of the stored data in each trip as a periodical storage number and may allow, the determining unit to execute abnormality determination on the condition that the periodical storage number has reached a third threshold in addition to the fact that the total storage number has reached the second threshold.

With the above configuration, in the second trip or later after there occurs the situation that no data are stored, abnormality determination is executed on the condition that new data of which the number corresponds to the third threshold are detected and stored in a trip, so abnormality determination may be executed on the basis of data that include the latest data of which the number is larger than or equal to the third threshold. Therefore, abnormality determination may be accurately executed in consistence with an actual state of the evaluation target device.

In the abnormality determination apparatus, the abnormality determination apparatus may include: a volatile memory that stores data detected by the detecting unit; and a battery that supplies electric power to the memory, and may determine that there occurs the situation that no data are stored because of the fact that supply of electric power from the battery to the memory is temporarily stopped.

In the apparatus that includes the volatile memory, when supply of electric power to the memory is temporarily stopped because of replacement of the battery, or the like, data (specifically, stored data or values calculated on the basis of the stored data) stored in the memory are lost. With the above configuration, in such a case, it may be determined that there occurs the situation that no data are stored.

In the abnormality determination apparatus, the determining unit may calculate a weighted average value of the multiple pieces of data each time the state quantity is detected by the detecting unit and stored, and may determine whether there is an abnormality through a comparison between the weighted average value and a predetermined determination value.

With the above configuration, when there occurs the situation that no data are stored, abnormality determination may be executed after the weighted average value used for abnormality determination sufficiently varies in consistence with an actual operating state of the evaluation target device for a certain period of time, so it is possible to execute the determination with high accuracy. Moreover, in the second trip or later after there occurs the situation that no data are stored, abnormality determination may be executed at the timing at which the weighted average value has varied to a minimally required degree to maintain determination accuracy, so it is possible to avoid an unnecessary delay of the timing at which determination result is obtained while suppressing deterioration in determination accuracy.

The above configuration may be applied to an apparatus that is applied to an engine system that includes an exhaust gas purification catalyst for purifying exhaust gas of an internal combustion engine to determine whether there is a degradation abnormality in the exhaust gas purification catalyst and that uses the detecting unit to detect an oxygen storage capacity of the exhaust gas purification catalyst as the state quantity.

What is claimed is:

1. An abnormality determination apparatus comprising:
a detecting unit that repeatedly detects a state quantity, which correlates with an operating state of an evaluation target device, at time intervals; and
a determining unit that determines whether there is an abnormality on the basis of multiple pieces of data about the state quantity, detected by the detecting unit and stored, wherein
the abnormality determination apparatus counts the number of the stored data as a total storage number after there occurs a situation that no data are stored, permits the determining unit to execute abnormality determination on the condition that the total storage number has reached a first threshold in a first trip after the situation occurs, and permits the determining unit to execute abnormality determination on the condition that the total storage number has reached a second threshold that is smaller than the first threshold in a second trip or later after the situation occurs.

2. The abnormality determination apparatus according to claim 1, wherein
in the second trip or later, the abnormality determination apparatus counts the number of the stored data in each trip as a periodical storage number and allows the determining unit to execute abnormality determination on the condition that the periodical storage number has reached a third threshold in addition to the fact that the total storage number has reached the second threshold.

3. The abnormality determination apparatus according to claim 1, further comprising:
a volatile memory that stores data detected by the detecting unit; and
a battery that supplies electric power to the memory, wherein
the abnormality determination apparatus determines that there occurs the situation that no data are stored because of the fact that supply of electric power from the battery to the memory is temporarily stopped.

4. The abnormality determination apparatus according to claim 1, wherein
the determining unit calculates a weighted average value of the multiple pieces of data each time the state quantity is detected by the detecting unit and stored, and determines whether there is an abnormality through a comparison between the weighted average value and a predetermined determination value.

5. The abnormality determination apparatus according to claim 1, wherein
the abnormality determination apparatus is applied to an engine system that includes an internal combustion engine and an exhaust gas purification catalyst for purifying exhaust gas of the internal combustion engine to determine whether there is a degradation abnormality in the exhaust gas purification catalyst, and
the detecting unit detects an oxygen storage capacity of the exhaust gas purification catalyst as the state quantity.

6. An abnormality determination method comprising
detecting repeatedly a state quantity, which correlates with an operating state of an evaluation target device, at time intervals;
determining whether there is an abnormality on the basis of multiple pieces of data about the state quantity that have been detected and stored in the detecting;
counting the number of the stored data as a total storage number after there occurs a situation that no data are stored;
permitting the determining to execute abnormality determination on the condition that the total storage number has reached a first threshold in a first trip after the situation occurs; and
permitting the determining to execute abnormality determination on the condition that the total storage number has reached a second threshold that is smaller than the first threshold in a second trip or later after the situation occurs.
